(19) United States
(12) Patent Application Publication
(10) Pub. No.: US 2004/0166897 A1
(43) Pub. Date: Aug. 26, 2004

(54) Wireless base station, control method for the same, program for implementing the method

(76) Inventor: Masashi Hamada, Tokyo (JP)

Correspondence Address: ROSSI & ASSOCIATES, P.O. Box 826, Ashburn, VA, 20146-0826, US

(21) Appl. No.: 10/728,083

(22) Filed: Dec. 4, 2003

(30) Foreign Application Priority Data
Dec. 9, 2002 (JP) 2002-356669 (PAT.

(51) Int. Cl. H04M 1/00

(52) U.S. Cl. 455/560

(57) ABSTRACT

There is provided a wireless base station that can ensure the mutual independence of wireless communication networks with overlapping communication cells. When a multifunction access point that is a present base station is to be newly activated inside a wireless communication cell controlled by another active multifunction access point in the periphery thereof, the wireless LAN unit of the multifunction access point carries out passive scan to receive beacons including an SSID from the other multifunction access point, and acquires the SSID included in the beacons. The wireless LAN unit automatically generates, using a predetermined generation algorithm, an SSID to be used in a wireless communication cell controlled by the present base station so that the generated SSID differs to a previously generated SSID. When the generated SSID is not identical with the acquired SSID, the generated SSID is set as the SSID of the wireless communication cell controlled by the present base station.

### BACKGROUND OF THE INVENTION

1. Field of the Invention

The present invention relates to a wireless base station for constructing one of mutually independent wireless communication networks where system identification codes are independently assigned on a network-by-network basis, a control method for the same, a program for implementing the method.

2. Description of the Related Art

Conventionally, there has been known a wireless base station that, together with one or more communication terminals, constructs one of mutually independent wireless communication networks, using one of system identification codes set on a network-by-network basis for a plurality of wireless communication networks. When the wireless base station sets various parameters for wireless communication, the state of usage of wireless communication networks in the periphery of the wireless base station is grasped and a user or a network administrator manually sets the system identification code for the wireless communication network to which the wireless base station belongs.

There has been also known a system, such as a conventional wireless base station disclosed by Japanese Laid-Open Patent Publication (Kokai) No. 2001-111575, that determines and automatically sets channels used for wireless communication based on the state of the periphery thereof.

However, in the wireless base station mentioned above in which the system identification code is set manually, the setting of the system identification code is based on only determination made by the user or network administrator. This means that through carelessness, for example, there are cases where a system identification code that is identical to a system identification code used by another wireless base station belonging to another wireless communication network, which is in activity in a range where wireless communication cells controlled by these base stations overlap is erroneously set for the present base station. In such case, there is the risk of the mutual independence of the wireless communication networks not being ensured.

Further, although the other conventional wireless base station mentioned above can automatically set channels, it has not been possible to automatically set a system identification code for identifying a wireless communication network to which the wireless base station belongs.

### SUMMARY OF THE INVENTION

It is an object of the present invention to ensure the mutual independence of wireless communication networks with overlapping communication cells. It is another object of the present invention to keep a plurality of wireless base stations from interfering with communications therebetween.

To attain the above objects, in a first aspect of the present invention, there is provided a wireless base station that constructs a wireless communication network using a system identification code, comprising recognizing means for recognizing a system identification code used by another wireless base station and setting means for setting a system identification code used by the wireless base station, based on the system identification code recognized by the recognizing means.

To attain the above objects, in a second aspect of the present invention, there is provided a control method for a wireless base station that constructs a wireless communication network using a system identification code, comprising a recognizing step of receiving a system identification code used by another wireless base station, and a setting step of setting a system identification code used by the wireless base station, based on the system identification code recognized in the recognizing step.

To attain the above objects, in a third aspect of the present invention, there is provided a program for causing a computer to control a wireless base station that constructs a wireless communication network using a system identification code, comprising a recognizing module for recognizing a system identification code used by another wireless base station, and a setting module for setting a system identification code used by the wireless base station, based on the system identification code recognized by the recognizing module.

The above and other objects, features, and advantages of the invention will become more apparent from the following detailed description taken in conjunction with the accompanying drawings.

### BRIEF DESCRIPTION OF THE DRAWINGS

FIG. 1 is a schematic diagram showing the overall construction of a wireless communication network comprised of a plurality of wireless base stations according to a first embodiment of the present invention;

FIG. 2 is a block diagram showing the arrangement of functions of one of multifunction access points;

FIG. 3 is a diagram showing how an SSID information acquisition process is executed through passive scan by each of the multifunction access points, according to the first embodiment;

FIG. 4 is a flowchart showing the SSID information acquisition process executed through passive scan by each of the multifunction access points;

FIG. 5 is a schematic diagram showing the overall construction of a wireless communication network comprised of a plurality of wireless base stations according to a second embodiment of the present invention;

FIG. 6 is a diagram showing how an SSID information acquisition process is executed through active scan by each of the multifunction access points, according to the second embodiment; and

FIG. 7 is a flowchart showing the SSID information acquisition process executed through passive scan by each of the multifunction access points.

### DETAILED DESCRIPTION OF THE PREFERRED EMBODIMENTS

The present invention will now be described in detail with reference to the accompanying drawings showing preferred embodiments thereof.

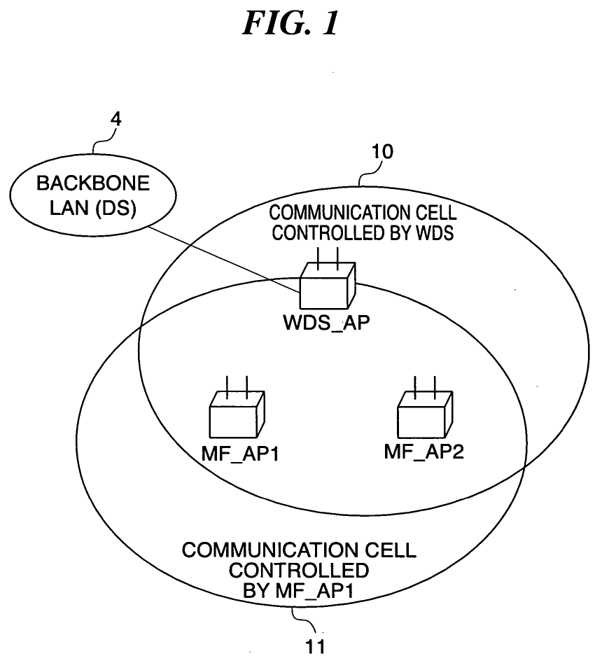

FIG. 1 is a schematic diagram showing the overall construction of a wireless communication network comprised of a plurality of wireless base stations according to a first embodiment of the present invention. This wireless communication network is constructed according to the wireless LAN standard (IEEE Std 802.11).

In FIG. 1, an access point WDS_AP as a wireless base station according to the first embodiment is in charge of connecting a wireless wide area network connecting system WDS (Wireless Distribution System) and a DS (Distribution System) 4 that is a backbone LAN. A plurality of multifunction access points MF_AP that are wireless base stations include multifunction access points MF_AP1 and MF_AP2. Reference numeral 10 designates a wireless communication cell (controlled wireless communication cell) that is controlled by the access point WDS_AP. Reference numeral 11 designates a wireless communication cell (controlled wireless communication cell) that is controlled by the multifunction access point MF_AP1.

In the present embodiment, a description will be given of an example of an automatic system identification code setting method in which a multifunction access point MF_AP that forms a new wireless communication cell automatically sets a system identification code SSID (Service Set Identifier) under an environment where the wireless LAN standard (IEEE Std 802.11) is used for wireless communication networks and the wireless wide area network connecting system WDS is connected to the backbone LAN DS 4. In this example, it is assumed that the multifunction access point MF_AP1 is already active and the multifunction access point MF_AP2 is about to be activated inside the controlled wireless communication cell 11 of the multifunction access point MF_AP1.

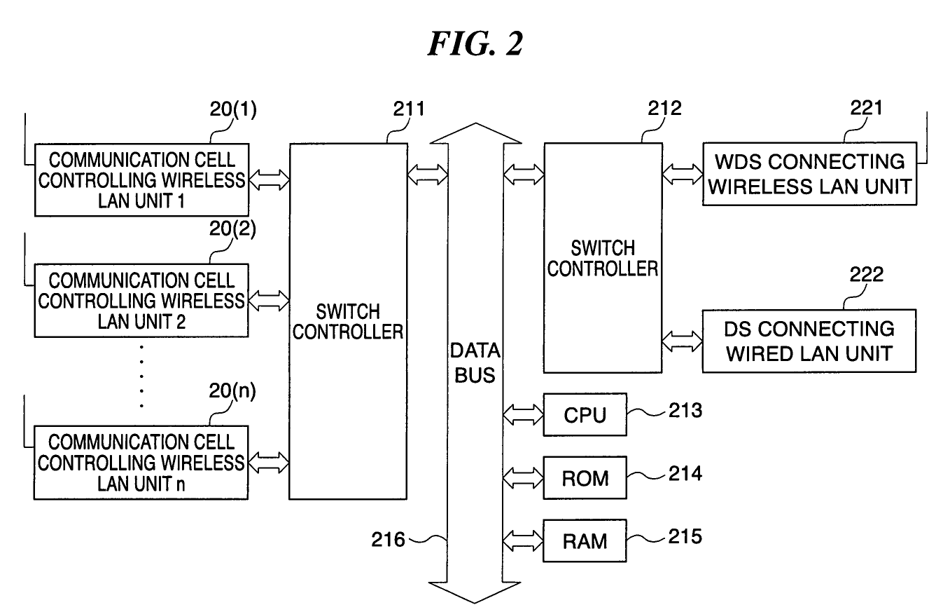

FIG. 2 is a block diagram showing the arrangement of functions of each of multifunction access points. The respective access points in the plurality of multifunction access points MF_AP have the identical construction.

Reference numerals 20(1) to 20(n) designate wireless LAN units (1 to n) for controlling wireless communication cells respectively corresponding to the wireless LAN units (1 to n). Although a plurality of wireless LAN units (1 to n) are provided in the illustrated example, only one may be provided. Reference numerals 211 and 212 designate switch controllers that are in charge of connecting to a data bus 216. Connected via the data bus 216 to a CPU 213 are a ROM 214, which stores a control program, and a RAM 215.

Reference numeral 221 designates a wireless LAN unit for connecting to the access point WDS_AP, and reference numeral 222 designates a wired LAN unit used when directly connecting to a DS without communicating via the wireless wide area network connecting system WDS. When the wireless wide area network connecting system WDS is not used, the wireless LAN unit 221 does not need to be provided.

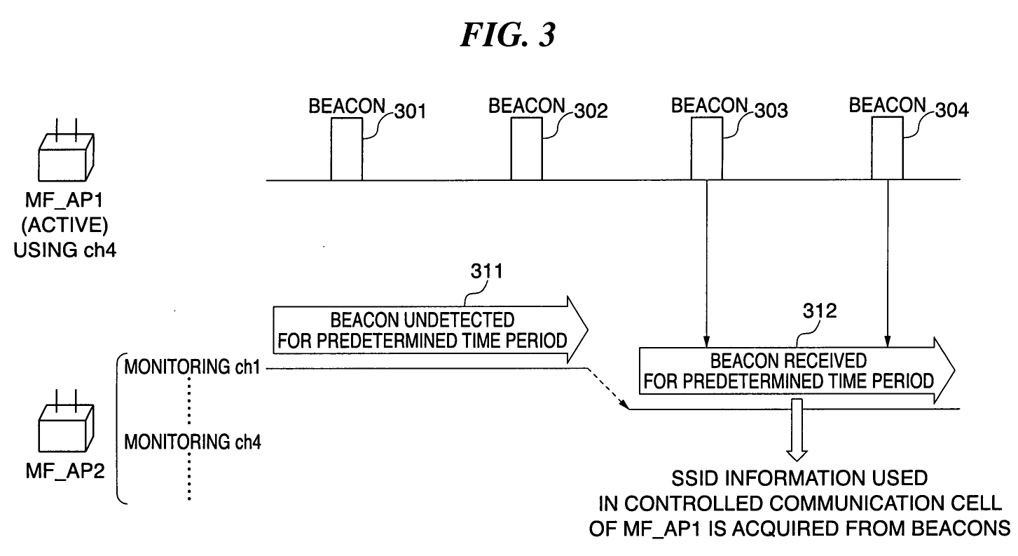

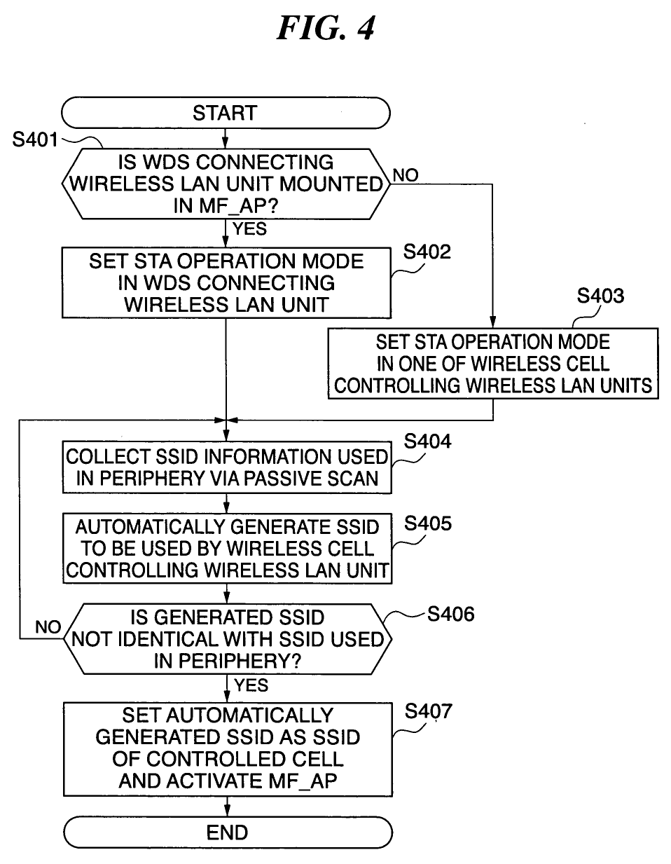

FIG. 3 is a diagram showing how an SSID information acquisition process is executed through passive scan by each multifunction access point. FIG. 4 is a flowchart showing the SSID information acquisition process achieved by passive scan carried out by each multifunction access point MF_AP. In particular, this process illustrates the case where on being activated, the multifunction access point MF_AP2 grasps an SSID from beacons (notification signal) transmitted from the multifunction access point MF_AP1 so as to avoid duplicated setting of the SSID.

First, in FIG. 4, when the multifunction access point MF_AP2 is to be newly activated, it is determined whether the wireless LAN unit 221 for connecting to the wireless wide area network connecting system WDS has been mounted in the multifunction access point MF_AP2 (step S401). When it is determined that the wireless LAN unit 221 has been mounted, a station STA (terminal) mode is set for the wireless LAN unit 221 (step S402), and the process proceeds to a step S404. On the other hand, when it is determined that the wireless LAN unit 221 has not been mounted, a station STA (terminal) mode is set for one of the wireless LAN units 20(1) to 20(n) (step S403), and the process proceeds to the step S404.

In the step S404, SSID information that is being used in the periphery of the multifunction access point MF_AP2 as “the present base station” (i.e. inside the range of the wireless communication cell of the multifunction access point MF_AP2) is gathered by carrying out passive scan. In other words, all channels that can be used by the multifunction access point MF_AP2 are each received for a stipulated time period (a time period that is no shorter than a maximum transmission interval for beacons as stipulated by infrastructure mode of IEEE 802.11 Standard). SSIDs included in the received beacons are thus acquired.

This will be explained with reference to FIG. 3. First, the multifunction access point MF_AP1, as another active base station, which is in activity in the periphery of the multifunction access point MF_AP2, uses channel ch4 to intermittently transmit beacons (301 to 304 . . . ) that include an SSID that is the system identification code. In this state, the multifunction access point MF_AP2 that is about to be activated inside the controlled wireless communication cell 11 of the multifunction access point MF_AP1 receives beacons for a predetermined time period on each of respective channels starting with channel ch1 (311). When no beacon is detected, the beacon receiving operation is carried out on the next channel. In the illustrated example, when channel ch4 is being received, beacons (303, 304) intermittently transmitted by the multifunction access point MF_AP1 are received (312).

The multifunction access point MF_AP2 extracts an SSID that is being used by the multifunction access point MF_AP1 and is included in the received beacons, and so acquires the SSID.

Referring again to FIG. 4, next in a step S405, an SSID for the wireless communication cell controlled by the multifunction access point MF_AP2 is automatically generated for use by the wireless LAN unit 20 corresponding to the wireless communication cell. The automatically generated SSID is intended for subsequent use. It is then determined whether the generated SSID is identical with the acquired SSID that is in use in the periphery of the present base station (step S406).

When it is determined that the SSIDs do not match, the automatically generated SSID is set as the SSID of the wireless communication cell controlled by the present base station (that is, an SSID for identifying the wireless communication network controlled by the present base station), the multifunction access point MF_AP2 is activated (step S407), and the present process is terminated. In this way, duplicated setting of an SSID can be avoided.

On the other hand, when the automatically generated SSID is identical with the acquired SSID mentioned above, the process returns to the step S404 and the collecting process for another peripheral SSID and the automatic generation of an SSID, etc., is repeated.

In the step S405 above, when an SSID is automatically regenerated, a predetermined generation algorithm that produces a different value for a regenerated SSID to the preceding value, such as by adding a number of regeneration iterations or the like to parameters for automatic generation, is used. By doing so, the automatic regeneration algorithm can be prevented from entering an infinite loop.

According to the present embodiment, in a range where wireless communication cells overlap, duplicated setting of an SSID for respective wireless communication networks can be automatically prevented. Further, an automatic generation algorithm that does not output the same result as before is used when SSID is regenerated, so that an SSID, which is not duplicated, can be automatically set in a short time. As a result, a SSID different to SSIDs that are being used by wireless communication networks which are in activity in the periphery of the present base station can be automatically set without having to make the user especially conscious of the operation. Further, the mutual independence of wireless communication networks with overlapping wireless communication cells can be ensured easily.

Next, a second embodiment of the present invention will be described with reference to FIG. 2 and FIGS. 4 to 7.

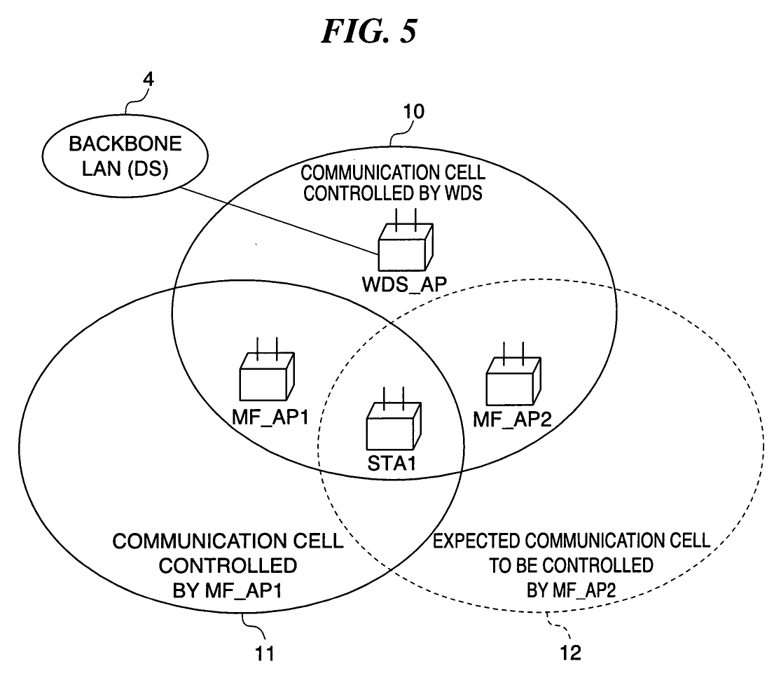

FIG. 5 is a schematic diagram showing the overall construction of a wireless communication network comprised of a plurality of wireless base stations according to the second embodiment of the present invention. This wireless communication network is constructed according to the wireless LAN standard (IEEE Std 802.11). In FIG. 5, component elements corresponding to those of the first embodiment are designated by identical reference numerals. Reference numeral 12 designates a wireless communication cell (expected controlled wireless communication cell) that is expected to be controlled by the multifunction access point MF_AP2 when the multifunction access point MF_AP2 is activated.

In the present embodiment, it is assumed that the multifunction access point MF_AP1 is already active and the multifunction access point MF_AP2 is about to be activated not inside the controlled wireless communication cell 11 of the multifunction access point MF_AP1 but outside the controlled wireless communication cell 11. Also, a wireless LAN station STA is assumed to be present inside both the expected controlled wireless communication cell 12 and the controlled wireless communication cell 11, and to be communicating with the multifunction access point MF_AP in infrastructure mode using channel ch4.

In the state shown in FIG. 5, that is, when the multifunction access point MF_AP1 is active and the multifunction access point MF_AP2 is yet to be activated, if the multifunction access point MF_AP2 is to automatically set an SSID through only an SSID information acquisition process achieved by passive scan as was described in the first embodiment, it is possible to receive beacons transmitted from the multifunction access point MF_AP1 since the multifunction access point MF_AP2 is outside the controlled wireless communication cell 11. Accordingly, there is the possibility of the multifunction access point MF_AP2 automatically setting the same SSID as the multifunction access point MF_AP1.

In addition, the wireless LAN station STA1 is present in an overlapping part of the expected controlled wireless communication cell 12 and the controlled wireless communication cell 11. This means, for example, that even though the wireless LAN station STA1 should basically be able to access only the wireless communication network of the multifunction access point MF_AP1, there is the possibility of the wireless LAN station STA1 be able to access only an unexpected wireless communication network, such as a wireless communication network of the multifunction access point MF_AP2.

In the second embodiment, the above situation is remedied by using an automatic setting process for the SSID, which uses the results of active scan, in addition to the automatic setting of the SSID by the SSID information acquisition process achieved by passive scan as described for the first embodiment.

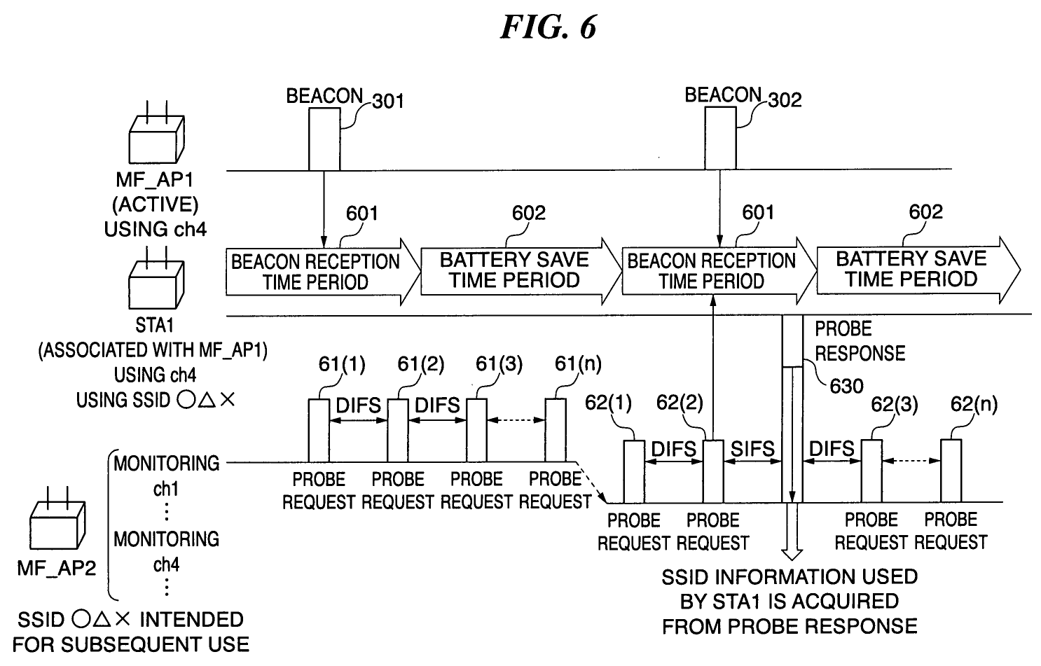

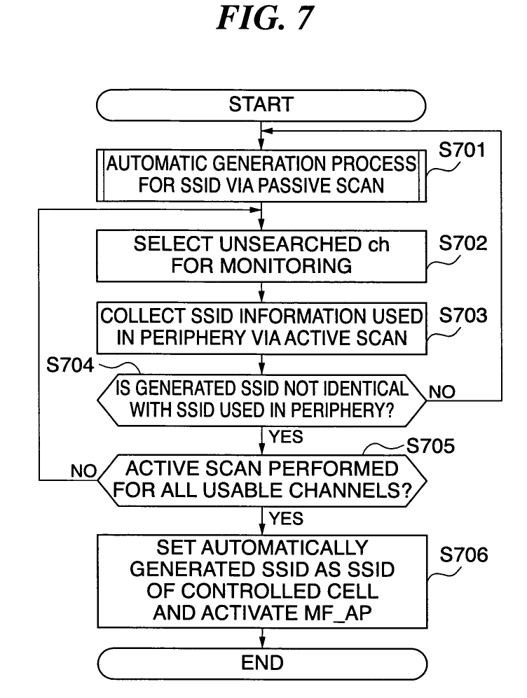

FIG. 6 is a diagram showing how an SSID information acquisition process is executed through active scan by each of the multifunction access points MF_AP. FIG. 7 is a flowchart showing the SSID information acquisition process executed through passive scans by each of the multifunction access points MF_AP. In particular, this process illustrates the case where the multifunction access point MF_AP2 automatically sets an SSID by carrying out passive scan and then automatically sets the SSID as necessary by carrying out active scan so as to avoid duplicated setting of the SSID.

First, in a step S701 of FIG. 7, the same process as in the steps S401 to S406 of FIG. 4 is carried out. When the result of the determination in the step S406 is that the SSID automatically generated in the step S405 is not identical with the SSID acquired in the step S404, the SSID that has been generated at this time is set as an SSID for use from now onwards.

Next, an unsearched channel (that is, a channel on which a probe request frame, described later, has not been transmitted) is selected for monitoring out of the channels that can be used by the multifunction access point MF_AP2 (step S702). After this, an active scan is carried out to collect information on an SSID that is being used in the periphery (that is, in a range of the expected controlled wireless communication cell 12 of the multifunction access point MF_AP2)(step S703). That is, probe request frames are continuously transmitted for a stipulated time period on the monitored channel mentioned above. The SSID included in a probe response frame sent in response is then acquired.

This will be explained with reference to FIG. 6. First, the multifunction access point MF_AP1, which is another base station being active in the periphery of the multifunction access point MF_AP2 (the “present base station”), uses channel ch4 to intermittently transmit beacons (301, 302, . . . ) that include an SSID.

In this state, the wireless LAN station STA1 repeatedly carries out an operation of receiving a beacon in a beacon reception time period 601 that is stipulated by the infrastructure mode of IEEE 802.11 Standard and interrupts the receiving during a battery save time period 602 that is also stipulated by the infrastructure mode. The SSID used by the wireless LAN station STA1 is assumed to be “∘ΔX”.

On the other hand, the multifunction access point MF_AP2 that is about to be newly activated outside the controlled wireless communication cell 11 continuously transmits probe request frames on the channel (such as channel ch1 at first) selected for monitoring, for the stipulated time period (the sum of the beacon reception time period 601 and the battery save time period 602 mentioned above) at stipulated minimum intervals (DIFS) between frames (61(1) to 61(n), 62(1) to 62(n)). In the illustrated example, the probe request frames are frames in which the same value “∘ΔX” as the SSID used by the wireless LAN station STAL is set.

Next, monitoring is performed for a probe response frame sent in response to the probe request frames.

In the illustrated example, the wireless LAN station STA1 is communicating with the multifunction access point MF_AP1 using channel ch4, so that a probe request frame is transmitted to a network group including the wireless LAN station STA1 (i.e., a network group with the same SSID) for the first time when a probe request frame is transmitted on channel ch4. In this case, after the lapse of a minimum stipulated time period SIFS (SIFS<DIFS) for responding, the wireless LAN station STA1 returns a probe response frame (a frame whose SSID is set at “OΔx” (630).

Since the multifunction access point MF_AP2 carries out carrier sense for at least the DIFS time period during continuous transmission, the multifunction access point MF_AP2 can receive the probe response frame (630) returned from the wireless LAN station STA1 after the lapse of the time period SIFS, even during the continuous transmission of probe request frames.

Thus, the multifunction access point MF_AP2 receives the probe response frame and acquires the SSID in the probe response frame. From the acquired SSID, the multifunction access point MF_AP2 recognizes that there is a wireless LAN station that has the same SSID set thereto in the periphery of the present base station, i.e. multifunction access point MF_AP2, and so can recognize that the SSID that has been automatically generated for the present base station is set in duplication.

Returning to FIG. 7, it is determined whether the automatically generated SSID is identical with the SSID acquired from the probe response frame (step S704). When this determination finds that SSIDs are identical with each other, the process returns to the step S701 and the passive scan and active scan process is repeated.

On the other hand, when the automatically generated SSID is not identical with the SSID acquired from the probe response frame, it is determined whether the active scan has been completed for all the channels that can be used (step S705). As a result of this determination, when the active scan has not been completed for all the channels, the process returns to step S702 and the active scan process is repeated for the remaining channel or channels. On the other hand, when the active scan has been completed for all the channels, the automatically generated SSID is set as the SSID of the wireless communication cell controlled by the present base station, and the multifunction access point MF_AP2 is activated (step S706), followed by the present process is terminated.

According to the present embodiment, even in the case where the multifunction access point MF_AP2 is newly activated outside the controlled wireless communication cell 11 of the multifunction access point MF_AP1, active scan is carried out so as to receive a probe response frame from the wireless LAN station STA1 present in both the controlled wireless communication cell 11 and the controlled wireless communication cell 12, which makes it possible to know duplicated setting of the SSID. When the SSID is set in duplication, such duplication can be avoided by repeating the process starting from the passive scan. As a result, compared with the first embodiment, the duplication of the SSID can be automatically detected with higher accuracy, and the mutual independence of wireless communication networks with overlapping wireless communication cells can be easily ensured, even when a wireless base station is located outside the wireless communication cell of another wireless base station.

Although in the first and second embodiments described above, the SSIDs used by the wireless LAN units 20 are automatically generated, the present invention is not limited to the automatic generation and a construction where an SSID is manually generated by the user in the step S405 in FIG. 4. In this case, when the result of the determination in the step S406 in FIG. 4 or the step S704 in FIG. 7 is that the generated SSID is identical with the acquired SSID, it is preferable to warn the user using a predetermined warning message and to display the SSID set in duplication so as to urge the user to input a different SSID. By doing so, the SSID duplication detection can be applied to a validity checking process when the system identification code (SSIDs) is changed (customized) by the user.

Further, although the above described SSID information acquisition process using passive scan in FIG. 4 (or the step S701 of FIG. 7) is carried out when a multifunction access point MF_AP is activated, the present invention is not limited to this timing and the SSID information acquisition process may be carried out during an automatic or manual changing operation for the SSID, for example.

Although in the first and second embodiments, a wireless LAN (a system based on IEEE 802.11 Standard) is employed as a wireless communication medium, the present invention can be effectively applied to any other wireless communication medium (such as a cordless telephone system) that includes system identification codes.

Furthermore, although in the first and second embodiments, the case where there are two multifunction access points MF_AP and one wireless LAN station STA1 is illustrated above, the present invention can be applied in the same way to other cases where more devices or apparatuses are involved.

It is to be understood that the object of the present invention may also be accomplished by supplying a system or an apparatus with a storage medium in which a program code of software which realizes the functions of either of the above described embodiments is stored, and causing a computer (or CPU or MPU) of the system or apparatus to read out and execute the program code stored in the storage medium.

In this case, the program code itself read out from the storage medium realizes the functions of either of the embodiments described above, and hence the storage medium in which the program code is stored constitutes the present invention.

Examples of the storage medium for supplying the program code include a floppy (registered trademark) disk, a hard disk, a magneto-optical disk, a CD-ROM, a CD-R, a CD-RW, a DVD-ROM, a DVD-RAM, a DVD-RW, a DVD+RW, a magnetic tape, a nonvolatile memory card, and a ROM. Further, it is to be understood that the functions of either of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium, into a memory provided on an expansion board inserted into a computer or in an expansion unit connected to the computer and then causing a CPU or the like provided in the expansion board or the expansion unit to perform a part or all of the actual operations based on instructions of the program code.

Although the present invention has been described with reference to various examples and embodiments, it should be obvious to those skilled in the art that the object and scope of the present invention are not limited to the description of or the drawings referred to by this specification and that various changes and modifications can be made as described in the appended claims.

What is claimed is:

1. A wireless base station that constructs a wireless communication network using a system identification code, comprising:
recognizing means for recognizing a system identification code used by another wireless base station; and
setting means for setting a system identification code used by the wireless base station, based on the system identification code recognized by said recognizing means.

2. A wireless base station according to claim 1, further comprising:
first receiving means for receiving a notification signal including a system identification code from the other wireless base station; and
wherein said recognizing means recognizes the system identification code used by the other wireless base station based on the notification signal received by said first receiving means.

3. A wireless base station according to claim 1, further comprising:
second receiving means for receiving a signal from a communication apparatus whose communication is controlled by the other wireless base station; and
wherein said recognizing means recognizes the system identification code used by the other wireless base station based on the signal received by said second receiving means.

4. A wireless base station according to claim 3, wherein said second receiving means receives a response signal responsive to a request from the wireless base station.

5. A wireless base station according to claim 1, wherein said setting means sets a system identification code different to the system identification code recognized by said recognizing means.

6. A wireless base station according to claim 1, further comprising:
generating means for generating the system identification code; and
wherein said setting means sets the system identification code generated by said generating means based on the system identification code recognized by said recognizing means.

7. A wireless base station according to claim 6, wherein said generating means generates a system identification code different to the system identification code previously generated, based on the system identification code recognized by said recognizing means.

8. A wireless base station according to claim 6, wherein said generating means automatically generates the system identification code.

9. A wireless base station according to claim 6, wherein said generating means generates the system identification code based on an operation by a user.

10. A wireless base station according to claim 1, wherein said recognizing means recognizes the system identification code used by a plurality of channels.

11. A wireless base station according to claim 1, wherein the system identification code is a Service Set Identifier for use in a wireless LAN communication according to IEEE.802.11 Standard.

12. A wireless base station according to claim 1, wherein said wireless base station is a access point for performing a wireless LAN communication according to IEEE 802.11 Standard.

13. A control method for a wireless base station that constructs a wireless communication network using a system identification code, comprising:
a recognizing step of receiving a system identification code used by another wireless base station; and
a setting step of setting a system identification code used by the wireless base station, based on the system identification code recognized in said recognizing step.

14. A program for causing a computer to control a wireless base station that constructs a wireless communication network using a system identification code, comprising:
a recognizing module for recognizing a system identification code used by another wireless base station; and
a setting module for setting a system identification code used by said wireless base station, based on the system identification code recognized by said recognizing module.
